(19) United States
(12) Patent Application Publication
(10) Pub. No.: US 2017/0061131 A1
(43) Pub. Date: Mar. 2, 2017

(54) Side-Channel Integrity Validation of Devices

(71) Applicant: Cisco Technology, Inc., San Jose, CA (US)

(72) Inventors: Omar Santos, Raleigh, NC (US); Christopher M. McCoy, Garner, NC (US); Catherine M. Pearce, Sunderland, MA (US); Carlos M. Pignataro, Raleigh, NC (US); Jeff Apcar, Willoughby (AU)

(21) Appl. No.: 14/840,419

(22) Filed: Aug. 31, 2015

(51) Int. Cl. G06F 21/57

(52) U.S. Cl. CPC G06F 21/577; G06F 2221/034

(57) ABSTRACT

Techniques are presented herein that validate integrity of a computing device. A command to a first processor of a security module of the computing device is received through an interface unit of the security module on a communication channel external to the computing device. A configuration of the security module cannot be changed by a second processor of the computing device which executes an operating system and at least one application on the computing device. In response to receiving the command, one or more memory devices of the computing device are directly accessed by the first processor independent from the second processor to validate integrity of the computing device.

### TECHNICAL FIELD

The present disclosure relates to security of computing devices.

### BACKGROUND

The Internet of Things (IoT) contains a large number of physical objects or “things” that include electronics, sensors, etc., and that are enabled with compute, network and storage capabilities. The compute, network and storage capabilities allow manufacturers or operators to connect to the IoT devices and to exchange data across a network infrastructure. Because of their capabilities, IoT devices become more and more vulnerable to being compromised by malicious parties and it is important to frequently prove an identity of these devices to ensure that the IoT devices operate as intended.

### BRIEF DESCRIPTION OF THE DRAWINGS

FIG. 1 is a block diagram illustrating a configuration of a computing device configured to perform the validity (attestation) methods presented herein according to an example embodiment.

FIG. 2 is a block diagram illustrating a networking system in which the methods presented herein may be employed according to an example embodiment.

FIG. 3 is a block diagram illustrating a configuration of the computing device in which a Low Power Wide Area Network communication channel is utilized according to an example embodiment.

FIG. 4 is a block diagram illustrating a configuration of the computing device in which an infrared communication channel is utilized according to an example embodiment.

FIG. 5 is a block diagram illustrating a configuration of the computing device in which a communication channel of a power supply line is utilized according to an example embodiment.

FIG. 6 is a sequence diagram depicting operations performed by the computing device and a server according to an example embodiment.

FIG. 7 is a flow chart depicting operations performed by the computing device and a server according to another example embodiment.

FIG. 8 is a flow chart depicting operations performed by the computing device to validate integrity of the computing device according to an example embodiment.

FIG. 9 is a block diagram illustrating a networking system in which the methods presented herein may be employed according to an example embodiment.

### DESCRIPTION OF EXAMPLE EMBODIMENTS

### Overview

Techniques are presented herein that validate integrity of a computing device. A command to a first processor of a security module of the computing device is received through an interface unit of the security module on a communication channel external to the computing device. A configuration of the security module cannot be changed by a second processor of the computing device. The second processor executes an operating system and at least one application on the computing device. In response to receiving the command, one or more memory devices of the computing device are directly accessed by the first processor independent from the second processor to validate integrity of the computing device.

### Example Embodiments

Attestation is a mechanism that is used to prove a device's identity to a remote party. Through attestation, a computing device's operating system and application software may be proven to be intact and trustworthy.

The computing device may be provided with a trusted platform module (TPM). The TPM may generally perform public key cryptographic operations, computing hash functions, key management and generation, secure storage of keys or any other secret data, random number generation, and integrity measurement. Attestation data may be signed by the TPM whose key is certified by a trusted Certificate Authority (CA) and the attestation data may be trusted to be accurate when it is signed by the TPM.

When the security of the computing device is attacked, investigation and cyber security forensics may be performed to gather and preserve attack evidence. According to the embodiments presented herein, to ensure that the attestation data is not compromised, an external independent communication channel may be provided between the TPM of the computing device and a security server, an intermediate infrastructure device, or some other device, which can only be controlled by the TPM.

Remote attestation of a device is a fairly significant challenge as one cannot always trust the method that the attestation is using, as it may itself be compromised if it is in the normal operating flow or communication path. The methods and systems disclosed herein provide a new way to validate that devices have not been tampered with by providing an out-of-band method to communicate with a component in the device.

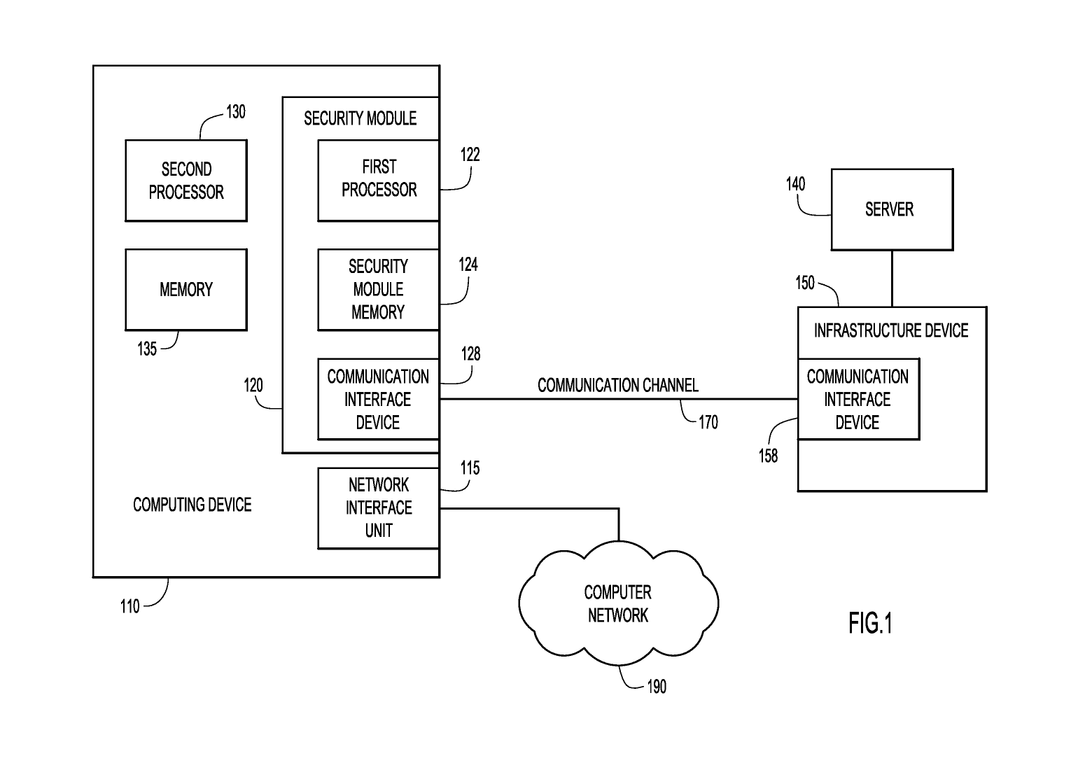

FIG. 1 is a block diagram illustrating a computing device 110 that is configured to perform the methods presented herein. Computing device 110 includes network interface unit 115, security module 120, second processor 130 and memory 135. The security module 120 includes a first processor 122, a security module memory 124 and a communication interface unit 128. In one embodiment, the second processor 130 executes instructions for an operating system stored in memory 135 and/or one or more applications also stored in memory 135. Network interface unit 115 connects computing device 110 with computer network 190 for network communications associated with normal operations of the device 110. Computer network 190 may be any type of (wired or wireless) network, such as the Internet, that allows computing device 110 to interconnect with other computing devices (not shown).

Memory 135 may include read only memory (ROM), random access memory (RAM), magnetic disk storage media devices, optical storage media devices, flash memory devices, electrical, optical, or other physical/tangible memory storage devices. Thus, in general, memory 135 may comprise one or more tangible (non-transitory) computer readable storage media (e.g., a memory device) encoded with software comprising computer executable instructions and when the software is executed (by the processor 130) it is operable to perform the operations of the operating system and the application software.

FIG. 1 further shows a security server 140 which is connected to infrastructure device 150. While server 140 may be a separate device as illustrated in FIG. 1, the functionality of server 140 may also be implemented in an infrastructure device 150. The infrastructure device 150 includes a communication interface unit 158 to enable communication with the computing device 110 over communication channel 170.

Computing device 110 may be interrogated by server 140 through the infrastructure device 150 via communication channel 170 to validate integrity of computing device 110. Communication channel 170 is exclusively controlled by security module 120 to prevent a malicious attacker from compromising data that is transmitted via communication channel 170. The communication channel 170 is referred to as a “side-band” or “out-of-band” channel because it is completely separate from the communication path used by the network interface unit 115 to enable inbound and outbound communications with the computing device 110 during normal operations of the computing device 110.

Communication interface units 128 and 158 may be configured to operate on various types of communication channels using various technologies, such as a low power wide area network (LPWAN) radio frequency channel, an infrared channel, or a communication channel via a power supply line.

LPWAN radio frequency channels may be implemented as Long Range WAN (LoRaWAN) radio frequency channels or by using wireless technologies such as those developed to provide wireless network infrastructure to connect low energy devices, such as IoT devices.

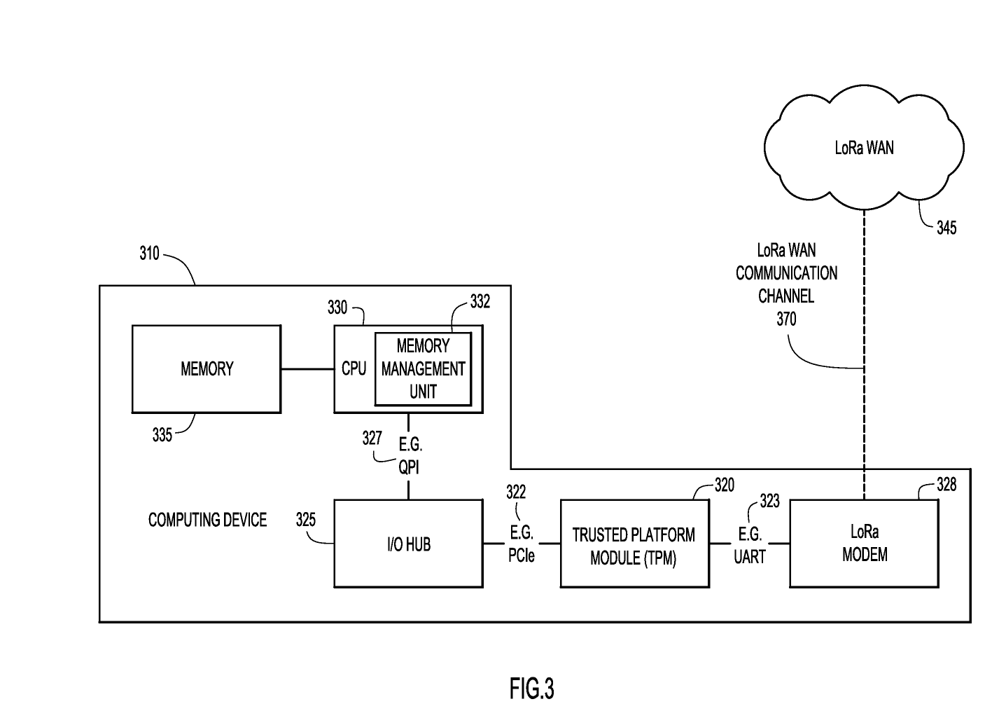

The security module 120 is configured to operate autonomously, i.e., its configuration cannot be changed by second processor 130 or by any other processor (not shown) that may be included in computing device 110, and that is not part of security module 120. As discussed in further detail with regard to FIG. 3 below, security module 120 may be a TPM that produces a hash value using a cryptographic one-way hash algorithm. The hash value may be assembled from information gathered from hardware elements in combination with software elements (the operating system, among others) of computing device 110.

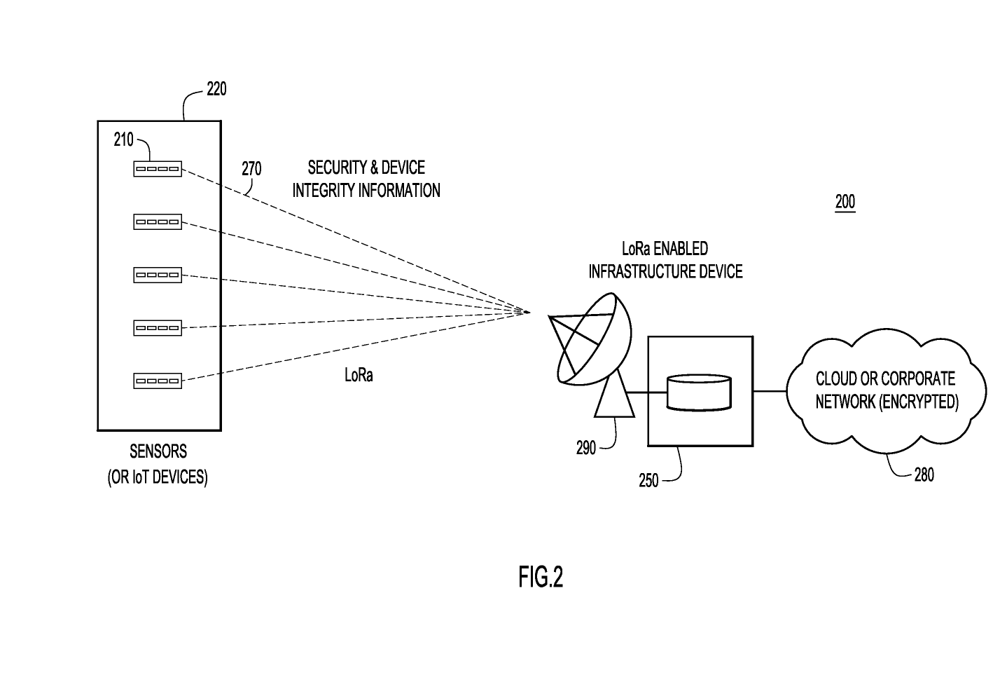

Reference is now made to FIG. 2. FIG. 2 is a block diagram illustrating a networking system 200 in which the techniques presented herein may be employed in accordance with one embodiment. More specifically, networking system 200 includes a plurality of IoT devices 210 the integrity of which is to be validated. The IoT devices 210 may take the form of sensors that reside at a facility 220. The IoT devices 210 may take the form of the computing device 110 shown in FIG. 1, and include a security module similar to security module 120. In general, devices 210 may be any type of computing device now known or hereinafter developed, such as a hand-held and wearable devices, Smartphones, personal computers, server computers, networking devices (switches, routers, firewalls, network security devices, etc.), desktop telephones, video endpoints, tablets, sensors, mobile low powered computing devices, etc.

The system 200 further includes an infrastructure device 250 (also known as a broker) to perform device integrity checks of the plurality of IoT devices 210 via LoRaWAN channels 270. The infrastructure device 250 may store security and device integrity information and report the security and device integrity information to a central security system which can be a cloud based service in a cloud or corporate network 280.

The LoRaWAN channels 270 are radio frequency channels that may be formed via antenna 290 of infrastructure device 250. The LoRaWAN channels 270 are independent from any other communication channel (such as communication channels formed via network interface unit 115 in FIG. 1) to and from IoT devices 210 and allow for a separate out-of-band path into each IoT device 210 for integrity validation.

LoRaWAN supports three classes (classes A, B and C) of end-point devices, such as IoT devices 210. Class A is provided for applications that only require downlink communication from the server or infrastructure device shortly after the end-point device has sent an uplink transmission, i.e., for bi-directional end-point devices with two short receive time slots enabled after any transmission from the end-point device. Downlink communication from the server or infrastructure device at any other time involves waiting until the Class A device transmits again (in a scheduled or unscheduled manner). Class B devices are bi-directional end-point devices with scheduled receive slots that open extra receive windows at scheduled times. In order for an end-point device to open a receive window at the scheduled time, it receives a time-synchronized Beacon from the infrastructure device. This allows the server or infrastructure device to know when the end-point device is listening. End-point devices of Class C are bi-directional end-point devices with continuous receive slots that have nearly continuously open receive windows.

According to an example embodiment, IoT devices 210 may be implemented as class A, B and C end-point devices. However, classes B and C are more suitable for continuous device interrogation as they are more likely to be mains-powered whereas class A end-point devices are typically powered by battery or by energy harvesting (for example by solar or by wind) or scavenging (by friction or by momentum). LoRaWAN class C end-point devices have nearly continuously open receive windows that are only closed when transmitting. LoRaWAN has characteristics which make it ideal for out-of-band attestation. LoRaWAN uses a Low Power Wide Area (LPWA) technology with spread-spectrum modulation in industrial, scientific and medical (ISM) radio bands, that reaches over long ranges such as 5 kilometers in dense urban areas, 15-30 kilometers in sub-urban areas and over 80 kilometers in Line of Sight (LOS) situations in which the view of transmitter and receiver is not obstructed by any object.

Referring still to FIG. 2, infrastructure device 250 (broker) may periodically interrogate IoT devices 210 and periodically collect hash values produced by the security modules of the IoT devices 210 along with memory dumps, and any configuration changes. In the event of an incorrect hash value or changes in the memory structure, orphan processes or changes in the underlying (predetermined) configuration the IoT devices 210 will be considered untrusted, and the infrastructure device 250 generates an alert to the security server (locally or in the cloud 280).

FIG. 3 is a block diagram illustrating a configuration of a computing device 310 which is similar to computing device 110 in FIG. 1, but which is specifically designed to support a side-band or out-of-band LoRaWAN communication channel. Computing device 310 includes TPM 320 that is connected via bus 322 (which may be a peripheral component interconnect express (PCIe) bus) with Input/Output (I/O) hub 325. The TPM 320 is also connected, via a universal asynchronous receiver/transmitter (UART) 323 to a LoRA modem 328. The LoRa modem provides an interface for the device 310 to the LoraWAN communication channel 370. I/O hub 325 is connected with CPU 330 via point-to-point processor interconnect 327. Point-to-point processor interconnect 327 may be implemented as QuickPath Interconnect (QPI). CPU 330 may include a memory management unit (MMU) 332 that controls access to memory 335.

TPM 320 periodically hashes security critical regions of memory 335 using bus-mastering and direct-memory access (DMA) techniques. Bus mastering is a feature supported by many bus architectures such as the PCIe bus that enables the TPM 320 to directly initiate transactions with memory 335 via MMU 332 without CPU 330.

TPM 320 may use a cryptographic one-way hash function such as Secure Hash Algorithm (SHA-2) or Secure Hash Algorithm Keccak/SHA-3 as hash functions. The hashed regions of memory 335 may include physical RAM or critical memory-mapped device configurations. Pointers to the regions of memory 335 to be hashed are programmed into TPM 320 at boot time and these locations in the physical memory cannot be changed under normal system operation of the device 310.

TPM 320 may not be able to properly hash the security-critical regions of memory 335 if paging or swapping is in use for the security critical memory regions. However, IoT devices rarely use swapping techniques. If, however, swapping is in use, memory 335 may be locked by TPM 320 using an application programming interface (API) like ‘mlock( )’.

If security critical regions of memory 335 need to be changed as part of a system operation, TPM 320 will be provided with an authenticated “command capsule” to do so by an operator through an in-band channel or through LoRaWAN out-of-band communication channel 370. Command capsules may be sequenced or timestamped to prevent them from becoming subject to replay attacks.

Security-critical regions of memory 335 include executable program text segments, kernel executable text segments, system call hook tables, virtual memory page directories/tables, system configuration, etc. Malware and root kits commonly hook/change this information as part of their operation to change system behavior and to provide a foothold into the network for an attacker. Accordingly, if a change in security critical regions of memory 335 is detected, this indicates that the computing device 310 has most likely been compromised by malware or root kits.

CPU 330 is not able to modify the configuration of TPM 320. Furthermore, it is not possible for CPU 330 to disable access by the TPM access to memory 335 via MMU 332. CPU 330 is further configured to provide sufficient bandwidth for memory access, i.e., to prevent CPU 330 from placing undue burden to TPM 320 to access memory 335 (memory bandwidth) under normal operation. A token bucket may be used to limit memory access on TPM 320. If TPM 320 is unable to access memory 335, TPM 320 raises an alarm to the network operator through the LoRaWAN communication channel 370 and computing device 310 is considered untrusted.

To minimize power consumption and provide earlier notification of computing device 310 being compromised, the CPU 330 can configure its MMU 332 and associated functions to notify TPM 320 that a change has taken place to security-critical regions of memory 335 and associated addresses so hashing may be done on demand. Even if this feature is provided, TPM 320 may still autonomously hash regions of memory 335 at an interval determined by the operator, e.g. hourly or daily. MMU 332 does not affect operations of TPM 320, i.e. TPM 320 operates on physical memory, not virtual memory.

The hashing of memory regions of memory 335 may be structured into a Merkle tree or a hash tree. A hash tree or Merkle tree is a tree in which every non-leaf node is labelled with the hash of the labels of its children nodes. Hash trees allow efficient and secure verification of the contents of large data structures. In the case where CPU 330 notifies TPM 320 of a change in the content of memory 335, only the blocks of memory 335 in the tree that need to be validated by TPM 320 need to be checked. The hash tree also permits secure verification of which memory regions have been changed without dumping the entire contents over a very low-capacity channel like LoRaWAN communication channel 370. It is also advantageous to structure the hash tree with a child for each category of memory 335, e.g. for system configuration, program executable segments, etc., so that changes can be quickly investigated.

The root of the hash tree (top hash) is signed by the TPM 320 and sent to the backend system over LoRaWAN channel 370 for further analysis. Computing device 310 may utilize Address Space Layout Randomization (ASLR) techniques to protect computing device 310 from buffer overflow attacks. In the case where ASLR is in use by computing device 310, the seed/keys used to generate random addresses to place the program in system memory 335 must be provided by the computing device 310 to TPM 320 to be sent over LoRaWAN communication channel 370 for analysis.

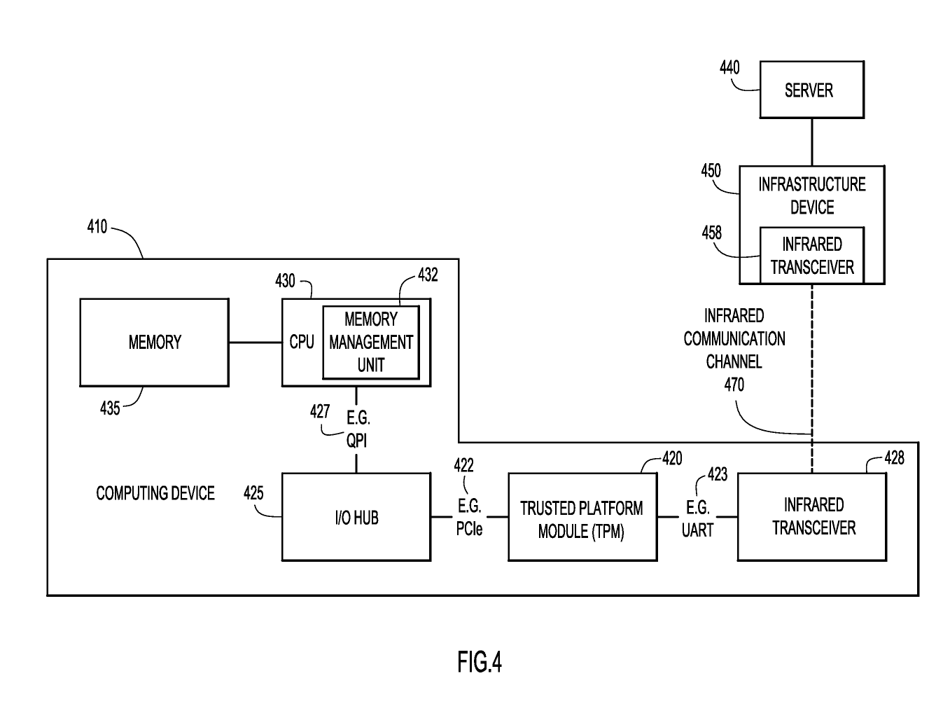

FIG. 4 is a block diagram illustrating a configuration of computing device 410 which is similar to computing device 110 in FIG. 1, but which is specifically designed to support a side-band or out-of-band infrared communication channel. TPM 420, I/O hub 425, CPU 430, MMU 432 and memory 435 are similar to TPM 320, I/O hub 325, CPU 330, MMU 332 and memory 335 in FIG. 3 and therefore, a detailed description of these elements is omitted here.

Infrared transceiver 428 is connected to TMP 420 via UART 423 and provides an interface to infrared communication channel 470 with infrared transceiver 458 of infrastructure device 450. Infrastructure device 450 is connected by a network (not shown) to security server 440 which may initiate interrogation of computing device 410 to validate its integrity.

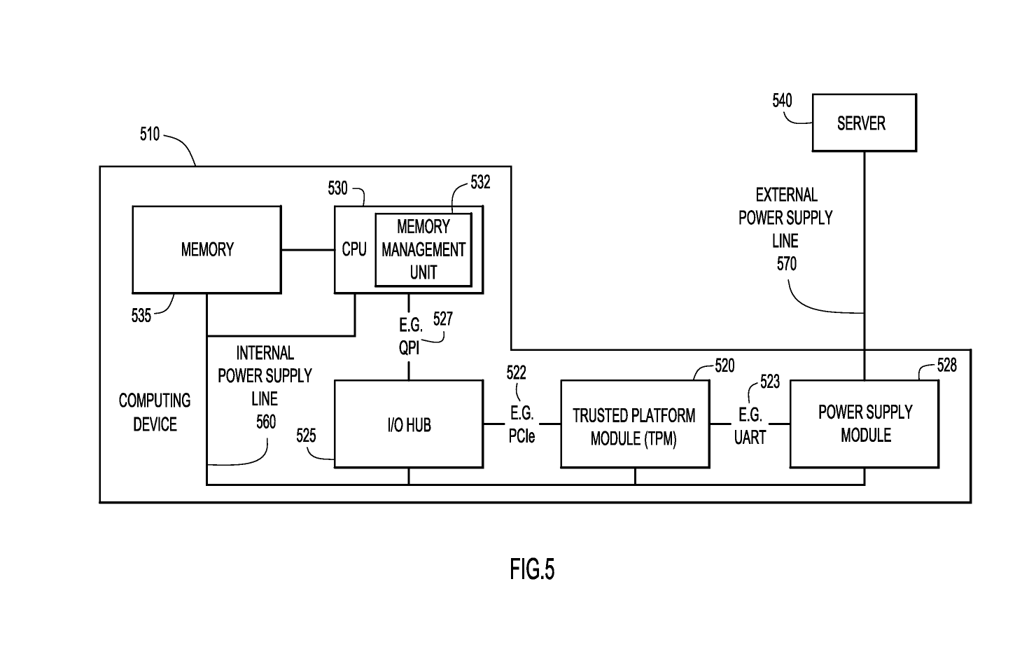

FIG. 5 is a block diagram illustrating a configuration of computing device 510 which is similar to computing device 110 in FIG. 1, but which is designed to support a side-band or out-of-band external power supply communication channel. TPM 520, I/O hub 525, CPU 530, MMU 532 and memory 535 are similar to TPM 320, I/O hub 325, CPU 330, MMU 332 and memory 335 in FIG. 3 and therefore, a detailed description of these elements is omitted.

As shown in FIG. 5, both, computing device 510 and server 540 are connected to a main power supply system that is also used for communication purposes. Specifically, power supply module 528 of computing device 510 provides power to TPM 520, I/O hub 525, CPU 530, MMU 532 and memory 535 with power via internal power line 560. In addition, supply module 528 is connected to TPM 520 via UART 523 to be controlled by TPM 520 to provide a communication channel to server 540 via external power supply line 570 (through one or more intervening networks, not shown) for validation of computing device 510 using techniques similar to those described above, but using the external power supply line 570 as a communication channel to the computing device 510.

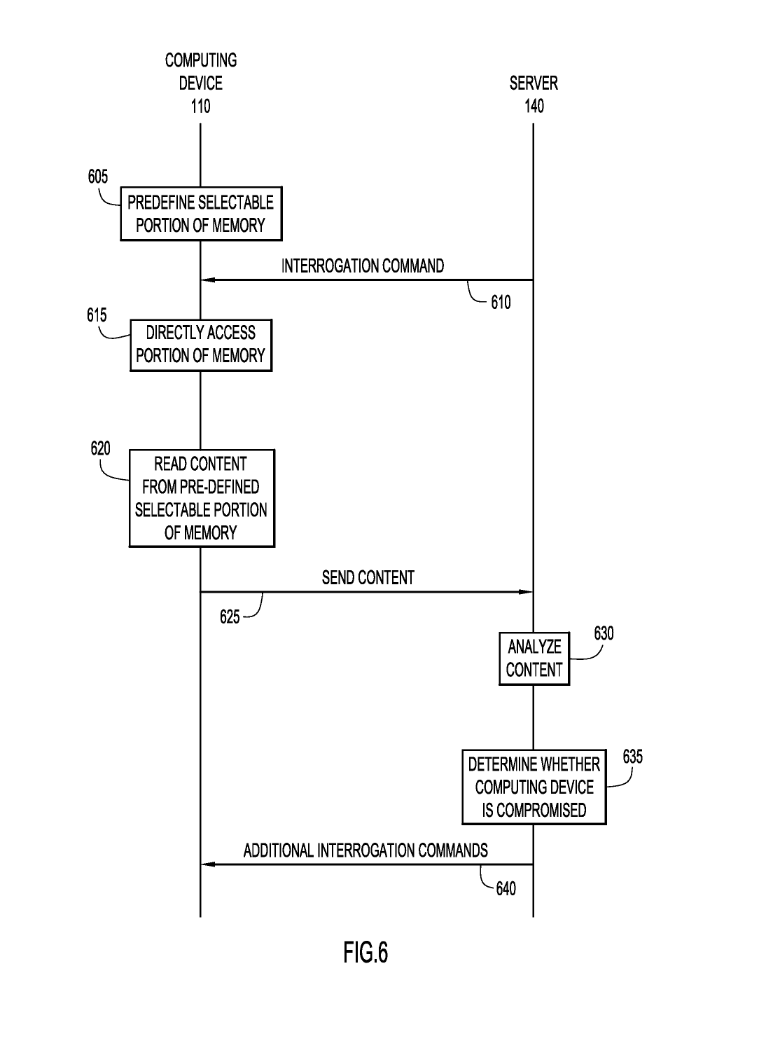

FIG. 6 is a flow chart depicting operations performed by the computing device 110 (or any of the devices 210, 310, 410 and 510 shown in FIGS. 2-5) and server 140 in FIG. 1 (or servers shown in FIGS. 2-5). For simplicity, computing device 110 and its components shown in FIG. 1 are referred to for purposes of the description of FIG. 6. At 605, selectable portions of memory 135 are predefined by security module 120 of computing device 110 to be accessed when the computing device 110 is interrogated by server 140. Server 140 can interrogate computing device 110 using security module 120 to retrieve all or parts of the hash tree, or by comparing a predetermined dump of memory 135 to a known good image/device, with the necessary corrections accounting for ASLR. The hash tree differences from the norm will determine which portions of memory to dump.

At 610, security module 120 receives interrogation command 610 from the server 140 via communication channel 170. In response, at 615, security module 120 directly accesses portions of memory 135 and at 620, security module 120 reads content from the predefined selectable portion of memory 135. The content is sent by security module 120 at 625 via communication channel 170 to server 140. At 630, server 140 analyzes the content received from security module 120 and at 635, server 140 determines whether computing device 110 is compromised based on the analysis of the content at 630. Depending on the results of the determination at 635, at 640, server 140 may send additional interrogation commands to security module 120 of computing device 110 to perform further investigation and cyber security forensics, and to gather and preserve cyber attack evidence, if any.

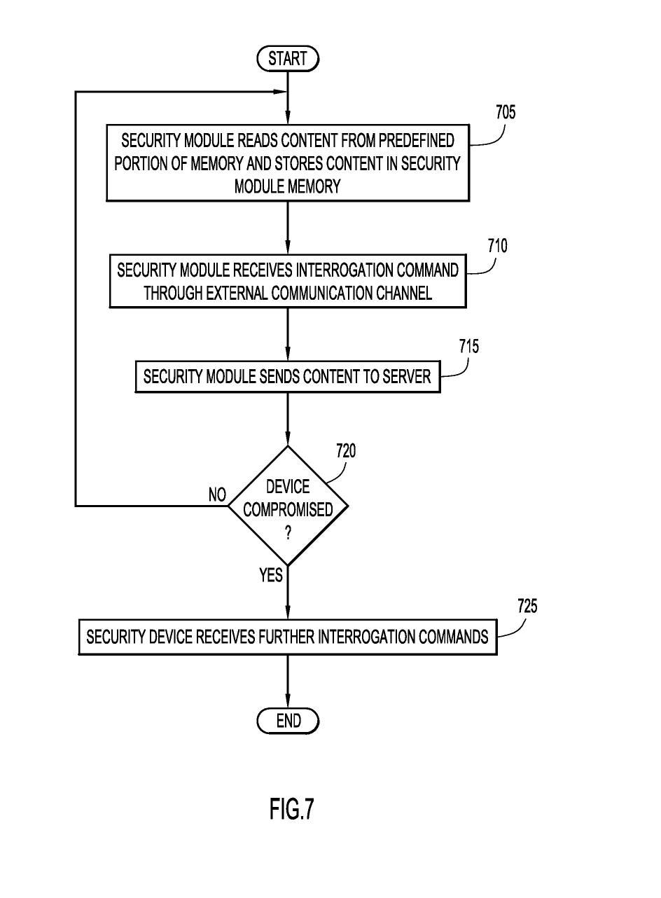

Referring now to FIG. 7, a flow chart depicting in more detail operations performed by computing device 110 (or any of the devices 210, 310, 410 and 510 shown in FIGS. 2-5) and server 140 (or servers shown in FIGS. 2-5). For simplicity, computing device 110 and its components shown in FIG. 1 are referred to for purposes of the description of FIG. 7. At 705, security module 120 reads content from predefined portions of memory 135 and stores the content in security module memory 124. In other words, security module 120 “freezes” and dumps a selectable amount of memory 135 (MemDump). MemDump is preferable small in size (in MBs) in order to be easily extracted via out-of-band communication channel 170.

At 710, security module 120 receives an interrogation command from server 140 through external communication channel 170. The interrogation command may be encrypted. If communication channel 170 is a LoRaWAN communication channel such as communication channel 370 shown in FIG. 3, encryption may be provided by the LoRaWAN.

At 715, security module 120 sends the content (MemDump) stored in security module memory 124 to server 140 via communication channel 170. At 720, the content is extracted, decoded and compared to a known-good system or memory reference to determiner whether computing device 110 is compromised. When it is determined that computing device 110 is not compromised, no further interrogation commands are received by security module 120 from server 140 and the operations continue at 705.

When it is determined at 720 that computing device 110 has been compromised, at 725, security module 120 receives further interrogation commands from a network administrator via server 140 to perform further investigation and cyber security forensics and to gather and preserve attack evidence.

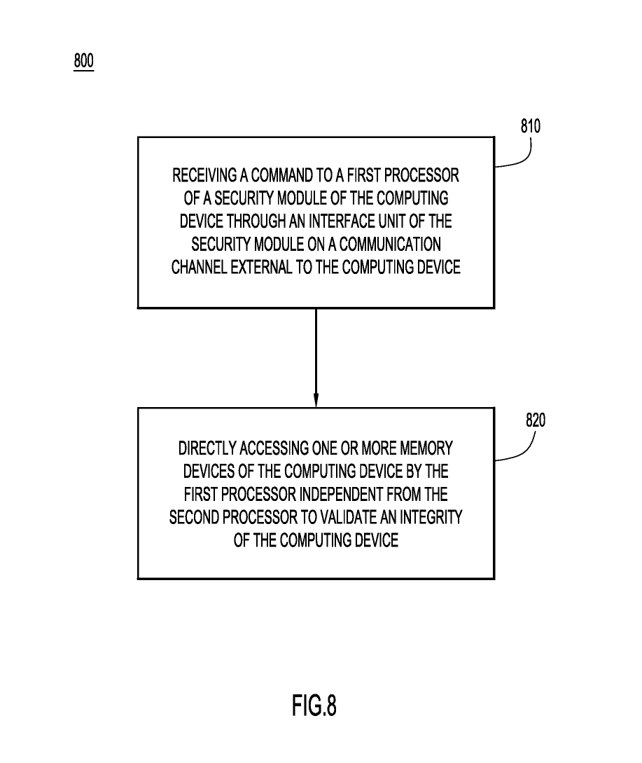

Referring now to FIG. 8, a high level flow chart of a method 800 according to an example embodiment is now described. This method is generic to any of the embodiments described above. Method 800 begins at 810 at which a security module of a device receives a command through communication interface unit of the security module via a communication channel.

At 820, in response to receiving the command at 810, the security module directly accesses a memory device of the computing device to validate integrity of computing device. Direct access to the memory may be provided to the security module by a memory management unit of a second processor of the computing device. The memory is directly accessed by the first processor of the security module independent from the second processor. This ensures that the configuration of the security module cannot be modified by the second processor which can also not control any communication via the communication channel with the computing device.

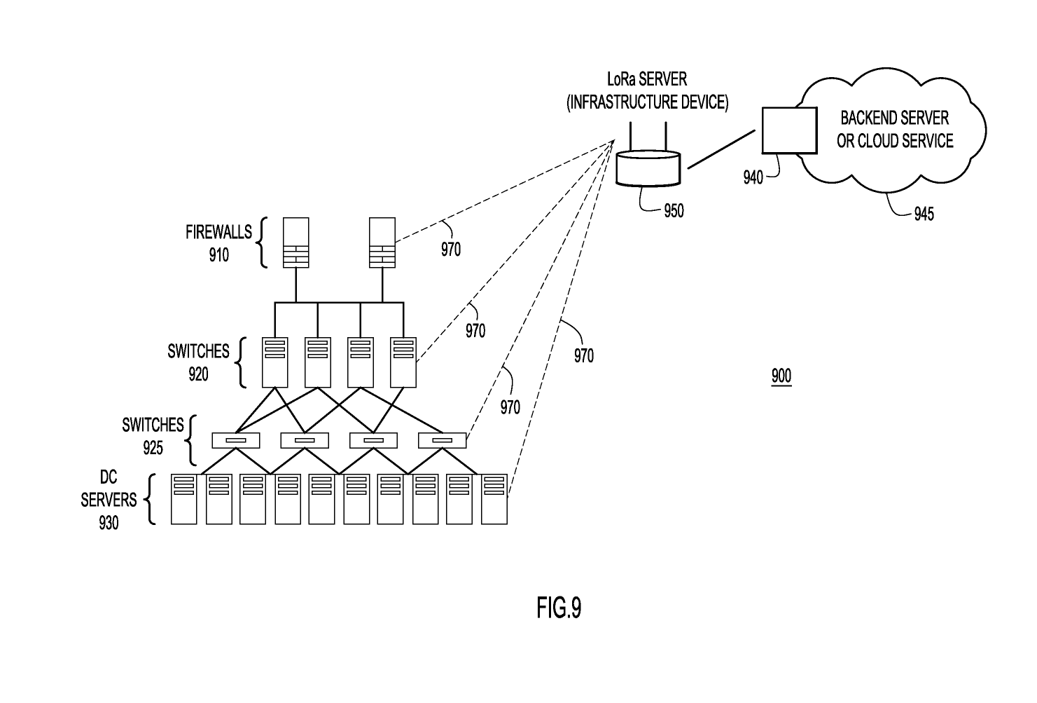

Referring now to FIG. 9 (with reference to FIGS. 1 and 2), a block diagram illustrating a networking system 900 in which the methods presented herein may be employed is described. Similar to IoT devices 210 depicted in FIG. 2, security modules may be installed in computing devices of a data center environment. More specifically, security modules may be installed in firewalls 910, switches 920, switches 925 and data center servers 930. Security modules of firewalls 910, switches 920, switches 925 and data center servers 930 may communicate via a communication channel 970 with an infrastructure device 950, which may be implemented as a LoRaWAN server, and which may be connected to a server 940 in cloud 945.

In an environment such as networking system 900, LoRaWAN Class C communication described in conjunction with FIG. 2 may be an appropriate method or class for communication through communication channels 970.

In summary, methods and systems for out-of-band remote memory interrogation are provided for integrity validation of IoT devices (sensors, wearables, mobile low powered computing devices, etc.) and other devices (e.g., data center devices) using any of a variety of communication technologies, including, but not limited to LoRa Low Power Wide Area Technology, infrared, power line communication, etc. These methods can also be used as a service for customers of a data center. Again, since selectable memory dumps may be small in size to be periodically collected and stored in a security module memory, communication channels for out-of-band remote memory interrogation may be utilized that cannot be controlled by a processor outside the security module which accesses the memory of the IoT device or the data center device.

In one form, a method is provided comprising: at a computing device, receiving a command to a first processor of a security module of the computing device through an interface unit of the security module on a communication channel external to the computing device, wherein a configuration of the security module cannot be changed by a second processor of the computing device; and in response to the command, directly accessing one or more memory devices of the computing device by the first processor independent from the second processor to validate an integrity of the computing device.

In another form, an apparatus is provided comprising a security module comprising a first processor and an interface unit, and which interface unit is exclusively coupled to the first processor and configured to operate on a communication channel external to the apparatus; one or more memory devices coupled to the first processor; and a second processor coupled to the one or more memory devices, wherein the interface unit cannot be controlled by the second processor, wherein the first processor is configured to: receive a command through the interface unit, and in response to the command, directly access the one or more memory devices independent from the second processor to validate an integrity of the apparatus.

In still another form, a system is provided comprising: a server; and a computing device comprising: a security module comprising a first processor and an interface unit, and which interface unit is exclusively coupled to the first processor and configured to operate on a communication channel external to the computing device; one or more memory devices coupled to the first processor; a second processor coupled to the one or more memory devices, wherein the interface unit cannot be controlled by the second processor, wherein the first processor is configured to: receive a command through the interface unit, and in response to the command, directly access the one or more memory devices independent from the second processor to validate an integrity of the apparatus.

In yet another form, a computer-implemented method is provided comprising: at a server, communicating with a computing device via a communication channel and receiving content read from a selectable portion of one or more memory devices of the computing device, wherein a configuration of a security module of the computing device that comprises a first processor that controls the communication channel cannot be changed by a second processor of the computing device, and wherein the first processor of the computing device directly accesses one or more memory devices of the computing device independent from the second processor to validate an integrity of the computing device; extracting and decoding security and device integrity information from the content read from the selectable portion of one or more memory devices of the computing device; comparing the extracted and decoded security and device integrity information with a memory reference; determining whether the computing device is compromised by a malicious attack based on the comparing of the extracted and decoded security and device integrity information with the memory reference.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a computing device, receiving a command to a first processor of a security module of the computing device through an interface unit of the security module on a communication channel external to the computing device, wherein a configuration of the security module cannot be changed by a second processor of the computing device, and
in response to the command, directly accessing one or more memory devices of the computing device by the first processor independent from the second processor to validate an integrity of the computing device.

2. The method of claim 1, wherein the security module is a trusted platform module (TPM).

3. The method of claim 1, wherein the interface unit is configured to operate on the communication channel that comprises a low power wide area network (LPWAN) radio frequency channel, an infrared channel, or a power supply line.

4. The method of claim 1, wherein the command originates from a server and causes access of the one or more memory devices to read content from a predefined selectable portion of the one or more memory devices; and further comprising:
sending the content read from the predefined selectable portion of the one or more memory devices via the interface unit over the communication channel to be delivered to the server.

5. The method of claim 4, further comprising:
executing an operating system and at least one application by the second processor; and
analyzing the content read from the predefined selectable portion of the one or more memory devices at the server to determine whether the operating system or the at least one application are compromised by a malicious attack.

6. The method of claim 5, wherein analyzing comprises extracting and decoding information from the content read from the predefined selectable portion of the one or more memory devices and comparing the extracted and decoded information with a reference.

7. The method of claim 4, wherein the security module comprises a security module memory, and
wherein pointers to the predefined selectable portion of the one or more memory devices are stored in the security module memory, and
wherein a location of the predefined selectable portion in the one or more memory devices does not change.

8. The method of claim 4, wherein the predefined selectable portion of the one or more memory devices comprises an executable program text segment, a kernel executable text segment, a system call hook table, a virtual memory page directory, or system configuration data.

9. The method of claim 1, further comprising:
periodically receiving the command to periodically gather content from the predefined selectable portion of the one or more memory devices; and
periodically sending the content gathered from the predefined selectable portion of the one or more memory devices via the interface unit over the communication channel.

10. The method of claim 4, further comprising:
upon determining that the one or more memory devices of the computing device cannot be accessed by the first processor, sending an alert message over the communication channel to be delivered to the server.

11. An apparatus comprising:
a security module comprising a first processor and an interface unit, and which interface unit is exclusively coupled to the first processor and configured to operate on a communication channel external to the apparatus;
one or more memory devices coupled to the first processor; and
a second processor coupled to the one or more memory devices, wherein the interface unit cannot be controlled by the second processor,
wherein the first processor is configured to:
receive a command through the interface unit, and
in response to the command, directly access the one or more memory devices independent from the second processor to validate an integrity of the apparatus.

12. The apparatus of claim 11, wherein the security module is a trusted platform module (TPM).

13. The apparatus of claim 11, the interface unit is configured to operate on the communication channel that comprises a low power wide area network (LPWAN) radio frequency channel, an infrared channel, or a power supply line.

14. The apparatus of claim 11, wherein the command originates from a server and causes the first processor to access the one or more memory devices to read content from a predefined selectable portion of the one or more memory devices, and
wherein the first processor is further configured to send the content read from the predefined selectable portion of the one or more memory devices via the interface unit over the communication channel to be delivered to the server.

15. The apparatus of claim 14, wherein the security module comprises a security module memory,
wherein pointers to the predefined selectable portion of the one or more memory devices are stored in the security module memory, and
wherein a location of the predefined selectable portion in the one or more memory devices does not change.

16. The apparatus of claim 14, wherein the first processor is configured to communicate with the server by:
periodically gathering content from the predefined selectable portion of the one or more memory devices; and
periodically sending the content from the predefined selectable portion of the one or more memory devices to the server.

17. The apparatus of claim 14, wherein the first processor is configured to send an alert message over the communication channel to be delivered to the server upon determining that the one or more memory devices of the computing device cannot be accessed by the first processor.

18. A system comprising:
a server; and
a computing device comprising:
a security module comprising a first processor and an interface unit, and which interface unit is exclusively coupled to the first processor and configured to operate on a communication channel external to the computing device;
one or more memory devices coupled to the first processor;
a second processor coupled to the one or more memory devices, wherein the interface unit cannot be controlled by the second processor,
wherein the first processor is configured to:
receive a command through the interface unit, and
in response to the command, directly access the one or more memory devices independent from the second processor to validate an integrity of the apparatus.

19. The system according to claim 18, wherein the computing device is a firewall, a switch or a router.

20. The system according to claim 18, wherein the security module is a trusted platform module (TPM).

21. The computer system according to claim 18, wherein the interface unit is configured to operate on the communication channel that comprises a low power wide area network (LPWAN) radio frequency channel, an infrared channel, or a power supply line.

22. A computer-implemented method comprising:
at a server, communicating with a computing device via a communication channel and receiving content read from a selectable portion of one or more memory devices of the computing device,
wherein a configuration of a security module of the computing device that comprises a first processor that controls the communication channel cannot be changed by a second processor of the computing device, and
wherein the first processor of the computing device directly accesses one or more memory devices of the computing device independent from the second processor to validate an integrity of the computing device;
extracting and decoding security and device integrity information from the content read from the selectable portion of one or more memory devices of the computing device;
comparing the extracted and decoded security and device integrity information with a memory reference;
determining whether the computing device is compromised by a malicious attack based on the comparing of the extracted and decoded security and device integrity information with the memory reference.

23. The computer-implemented method of claim 22, further comprising:
communicating with the computing device to perform additional investigation of the one or more memory devices.
